(19) United States
(12) Patent Application Publication
(10) Pub. No.: US 2006/0033909 A1
(43) Pub. Date: Feb. 16, 2006

(54) Reticle particle calibration standards

(76) Inventors: Gerald M. Bowers, Boonville, CA (US); Eutimio A. Saporetti, Littleton, MA (US); Clarence E. Thomas, Knoxville, TN (US); James R. Tallent, Austin, TX (US)

Correspondence Address: JOHN BRUCKNER, P.C., 5708 BACK BAY LANE, AUSTIN, TX, 78739, US

(21) Appl. No.: 11/188,382

(22) Filed: Jul. 25, 2005

Related U.S. Application Data
(60) Provisional application No. 60/590,571, filed on Jul. 23, 2004.
(60) Provisional application No. 60/590,572, filed on Jul. 23, 2004.
(60) Provisional application No. 60/590,593, filed on Jul. 23, 2004.

(51) Int. Cl. G01J 1/10

(52) U.S. Cl. 356/243.6

(57) ABSTRACT

Methods and apparatus are described for reticle particle calibration standards. A method includes making a reticle particle calibration standard including depositing a solution that includes a plurality of particles onto a first plate; drying the solution to evaporate a solvent; bonding the plurality of particles to the first plate; coupling a second plate to the first plate, the plurality of particles located between the first plate and the second plate, wherein the plurality of particles include a plurality of traceable standard particles of substantially known shape and size. An apparatus includes a reticle particle calibration standard including a first plate; a second plate coupled to the first plate, wherein the second plate is substantially parallel to and coincident with the first plate; and a plurality of traceable standard particles of substantially known shape and size i) located between the first plate and the second plate and ii) bonded to at least one plate selected from the group consisting of the first plate and the second plate. A method includes using a reticle particle calibration standard to qualify a metrology instrument or monitor performance of the metrology instrument including: scanning the reticle particle calibration standard using the metrology instrument; compiling a raw data map of the reticle particle calibration standard; comparing the raw data map to a calibration data map associated with the reticle particle calibration standard.

### CROSS-REFERENCES TO RELATED APPLICATIONS

This application is related to, and claims a benefit of priority under 35 U.S.C. 119(e) from copending provisional patent applications U.S. Ser. No. 60/590,571, filed Jul. 23, 2004; U.S. Ser. No. 60/590,572, filed Jul. 23, 2004; and U.S. Ser. No. 60/590,593, filed Jul. 23, 2004, the entire contents of all of which are hereby expressly incorporated herein by reference for all purposes.

### BACKGROUND INFORMATION

1. Field of the Invention

The inventions relates generally to the field of metrology. More particularly, embodiments of the invention relate to the field of reticle particle calibration standards.

2. Discussion of the Related Art

The use of calibration targets is known to those of skill in the art. U.S. Pat. No. 5,004,340 discloses a calibration target for surface analysis scanner systems.

There is a need for improved calibration targets for qualifying and monitoring particle inspection system performance in wafer fabs and photomask shops. There is also a need for improved methods of making such calibration targets and for improved methods of utilizing such calibration targets.

### SUMMARY OF THE INVENTION

There is a need for the following embodiments of the invention. Of course, the invention is not limited to these embodiments.

According to an embodiment of the invention, a process comprises making a reticle particle calibration standard including: depositing a solution that includes a plurality of particles onto a first plate; drying the solution to evaporate a solvent; bonding the plurality of particles to the first plate; coupling a second plate to the first plate, the plurality of particles located between the first plate and the second plate, wherein the plurality of particles include a plurality of traceable standard particles of substantially known shape and size. According to another embodiment of the invention, an apparatus comprises a reticle particle calibration standard including a first plate; a second plate coupled to the first plate, wherein the second plate is substantially parallel to and coincident with the first plate; and a plurality of traceable standard particles of substantially known shape and size i) located between the first plate and the second plate and ii) bonded to at least one plate selected from the group consisting of the first plate and the second plate. According to another embodiment of the invention, a process comprises using a reticle particle calibration standard to qualify a metrology instrument or monitor performance of the metrology instrument including: scanning the reticle particle calibration standard using the metrology instrument; compiling a raw data map of the reticle particle calibration standard; comparing the raw data map to a calibration data map associated with the reticle particle calibration standard.

These, and other, embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of an embodiment of the invention without departing from the spirit thereof, and embodiments of the invention include all such substitutions, modifications, additions and/or rearrangements.

### BRIEF DESCRIPTION OF THE DRAWINGS

The drawings accompanying and forming part of this specification are included to depict certain embodiments of the invention. A clearer conception of embodiments of the invention, and of the components combinable with, and operation of systems provided with, embodiments of the invention, will become more readily apparent by referring to the exemplary, and therefore nonlimiting, embodiments illustrated in the drawings, wherein identical reference numerals (if they occur in more than one view) designate the same elements. Embodiments of the invention may be better understood by reference to one or more of these drawings in combination with the description presented herein. It should be noted that the features illustrated in the drawings are not necessarily drawn to scale.

FIGS. 1A-1C are orthographic (1A-1B) and perspective (1C) views of a reticle particle calibration standard, representing an embodiment of the invention.

FIG. 2 is a display view of raw data (left side) and calibration data (right side) acquired and processed by a computer program, representing an embodiment of the invention.

### DESCRIPTION OF PREFERRED EMBODIMENTS

Embodiments of the invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the embodiments of the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

Within this application several publications are cited at the end of the specification immediately preceding the claims after the section heading References. The disclosures of all these publications in their entireties are hereby expressly incorporated by reference herein for the purpose of indicating the background of embodiments of the invention and illustrating the state of the art.

The below-referenced U.S. Patent discloses embodiments that are useful for the purposes for which they are intended. The entire contents of U.S. Pat. No. 5,004,340 are hereby expressly incorporated by reference herein for all purposes.

Overview

The reticle calibration standards is a software and hardware product for qualifying and monitoring particle inspection system performance in wafer fabs and photomask shops. It enables users to validate wafer or reticle inspection tool repeatability as well as supporting the creation of histograms for the tracking of reticle contamination control.

The invention can include the use of NIST traceable PSLs (Polystyrene Latex Spheres) of varying sizes appropriate to the application deposited on quartz reticle plates (or silicon wafers) using a method (described below) and mapped using particle inspection tools. The data maps of these substrates are provided along with the substrates for long term system performance tracking and calibration tests.

The method of particle deposition/processing creates a calibration standard that is durable and resistant to particle movement. Typically, static forces enable very small (<10μ) particles to remain stationary on calibration standards. Larger particles, have a tendency to shift or leave the surface altogether if not somehow adhered to the surface. This invention overcomes this problem for large particles.

The remainder of this document describes reticle standards. However, the production process is applicable to silicon substrates (wafers) as well.

Calibration Plate

The patterned side of reticles (containing the circuit pattern) is normally protected from contamination through the use of a pellicle. A pellicle is a nitrocellulose membrane stretched over a plastic frame approximately 4 to 6 mm from the patterned surface. Small particles (<8μ) on the pellicle surface are out of focus to lithography systems and do not adversely affect production.

Pellicles are typically very fragile and are easily damaged. In order to provide a more durable calibration standard, the pellicle is replaced with quartz of the same dimension. The two quartz plates are glue together using UV optical adhesive to produce a calibration reticle.

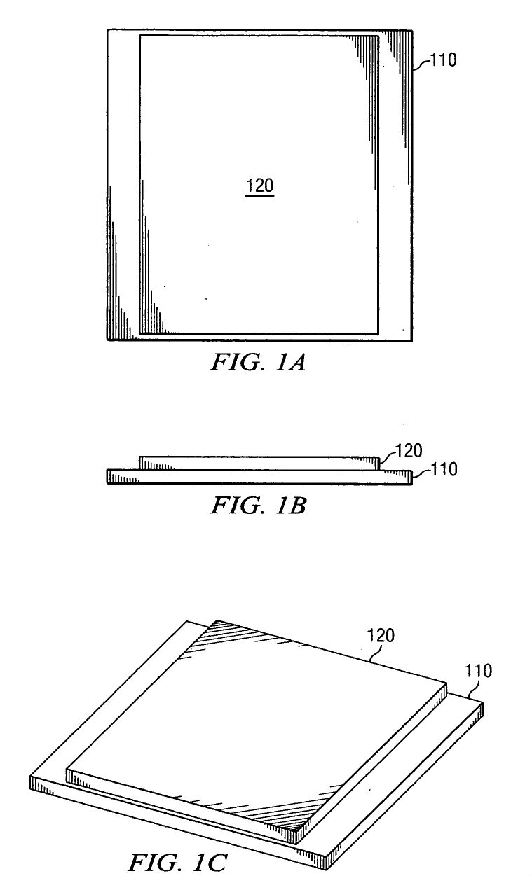

Referring to FIGS. 1A-1C, a calibration reticle is depicted. A first plate 110 provides a substrate for deposition of the particles. A second plate 120 is coupled to the first plate 110. The second plate 120 can be bonded to the first plate 110 with ultraviolet optical adhesive.

Calibration Software

Employing data mapping capability provided with the reticle calibration standards, the calibration software compares scan results. It validates that all standard particles were correctly detected. It displays both raw data (all particles, including adders) and calibration data (standard particles correctly detected and those missed). From the latter, it computes a repeatability score.

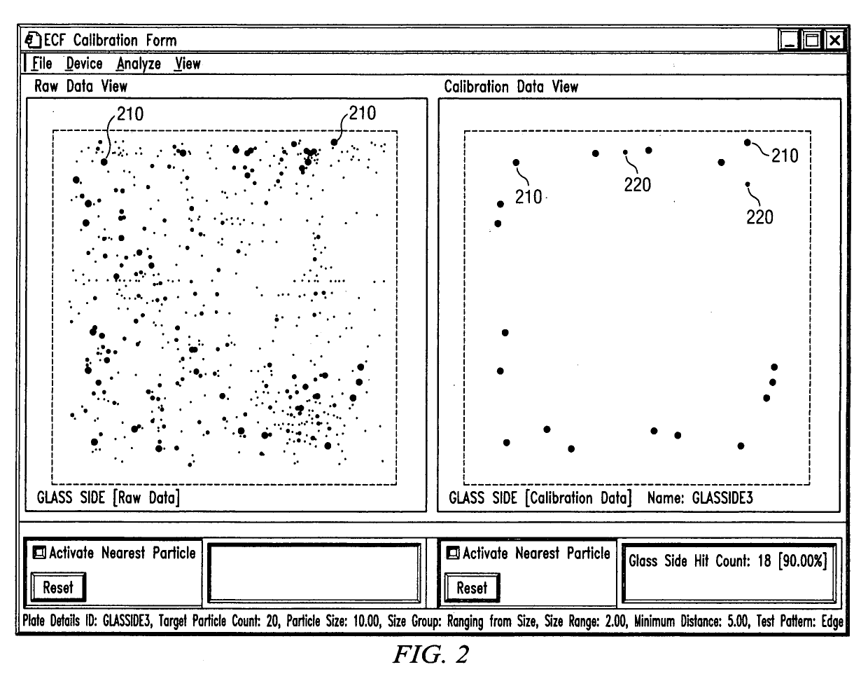

Referring to FIG. 2, uniform sized round shaped objects 210 appear in both the raw data view (left hand side) and calibration data view (right hand side). The round objects 210 represent the particles which were found to match both calibration and raw data plate data. Diamond shaped particles 220 on the calibration data view represent those standard particles which were missed by the tool. The test results are printed in the text box located in the lower right hand side of the screen.

The software also provides the ability to define new standard data maps. Particles may be selectively chosen from raw scan results after verification with a microscope or other method.

Production Method

Suitable solutions containing traceable standard particles of substantially known shape and size are available from Duke Scientific Corporation of Palo Alto, Calif., USA. These solutions contain 90% or more by weight of water and solid polymer microspheres composed of polystyrene or polystyrene divinylbenzene or other styrene copolymers. Of course, shapes other than spheres can be utilized as the particles (e.g., plates, cylinders, pyramids, cubes, 8 sided shapes, etcetera). To reduce the number of multi-particle clusters that are deposited, the nebulizer or spray orifice should be larger than the particles, but not too larger (e.g., less than or equal to five times the average diameter of the particles). To reduce the number of water rings remaining after drying, highly deionized water should be used to dilute the solution of particles.

Dilution

Commercial, high density PSL solutions of the appropriate size are diluted to provide an optimum concentration for deposition. The following procedure is used for dilution:

Prepare a 300 ml beaker with de-ionized (DI) water filtered to <0.2μ.

Fill a 30 ml disposable clean plastic cup with clean DI water from the beaker and put in one drop particle solution. Stir well.

Fill another 30 ml disposable clean plastic cup with clean DI water from the beaker and transfer one drop from the first cup. Stir well.

Repeat procedure until the standard particles are diluted to the appropriate level.

Deposition

Particles are applied using either a ‘nebulizer’ or fogger of the type typically employed for asthma medicine application, or a small commercial paint spray gun. For the preferred method using the nebulizer, the reticle is placed in a containment box that limits the distribution of the particle containing fog. The particle containing fog is applied, allowed to dry, then tested in the particle detection system. Further applications are made until the desired particle population is achieved.

For applications using the spray gun, the distance between the spray gun and the sample is typically ˜15-20 cm. The particle solution on the sample is allowed to dry; then the reticle is tested in the particle detection system. Further applications of particle may be made to get the desired particle population.

Thermal Processing

An infrared heat source is used to thermally bond the PSL particles to the glass reticle plates. A commercial heating lamp is fixed a defined distance behind a holder for the target reticle. The reticle is held with the particle sprayed surface horizontal and facing upward. A non-contact pyrometer placed so as to read the temperature at the particle sprayed surface of the reticle.

The heat lamp is turned on for ˜5 minutes to warm up before the reticle is placed on the apparatus. The reticle plate is then placed on the apparatus and heated until reaching the thermal fusion temperature of the PSL particles. This is typically in the 135° C. range, but may vary due to factors of reticle size, particle size, and specific PSL composition. Once the thermal bonding temperature is reached, the lamp is turned off and the target reticle is allowed to cool. The reticle is then scanned to confirm that the desired particle population is present.

Particle Scanning

To create a preliminary data map, the substrate is scanned using separate systems with known performance. The calibration software is used to identify particles that may be used in a baseline data map.

Microscope Examination

Particles identified in the preliminary data map are examined under a 20× microscope.

Nominally, the deposition process should produce at least 70% single particles and no more than 30% clusters of two or more. There will also be some irregular sizes of particle deposited on the surface of standard sample and some particles may exhibit water rings (residue from evaporated water). Single particles with the absence of significant deformation or water rings are selected for repeatability testing.

For particle detection systems, in order to prove 95% repeatability, at least 19 out of 20 particles must be detected and correctly sized. By identifying the locations of 100 particles of known size, systems claiming 99% repeatability may be tested.

For reticle applications, surface particle scanning systems typically are tuned for both pellicle (nitrocellulose) and reticle (quartz) surfaces, so replacing the pellicle with quartz is appropriate and novel.

An embodiment of the invention can also be included in a kit-of-parts. The kit-of-parts can include some, or all, of the components that an embodiment of the invention includes. The kit-of-parts can be an in-the-field retrofit kit-of-parts to improve existing systems that are capable of incorporating an embodiment of the invention. The kit-of-parts can include software, firmware and/or hardware for carrying out an embodiment of the invention. The kit-of-parts can also contain instructions for practicing an embodiment of the invention. Unless otherwise specified, the components, software, firmware, hardware and/or instructions of the kit-of-parts can be the same as those used in an embodiment of the invention.

### Advantages

Embodiments of the invention can be cost effective and advantageous for at least the following reasons. A primary advantage of this process is the immobility of particles on the glass reticle substrates. By eliminating reliance on purely static forces to adhere particles, particle shift or loss is eliminated, thus creating a usable long-term calibration standard. Embodiments of the invention improve quality and/or reduce costs compared to previous approaches.

### Definitions

The term program and/or the phrase computer program are intended to mean a sequence of instructions designed for execution on a computer system (e.g., a program and/or computer program, may include a subroutine, a function, a procedure, an object method, an object implementation, an executable application, an applet, a servlet, a source code, an object code, a shared library/dynamic load library and/or other sequence of instructions designed for execution on a computer or computer system). The term substantially is intended to mean largely but not necessarily wholly that which is specified. The term approximately is intended to mean at least close to a given value (e.g., within 10% of). The term generally is intended to mean at least approaching a given state. The term coupled is intended to mean connected, although not necessarily directly, and not necessarily mechanically. The term proximate, as used herein, is intended to mean close, near adjacent and/or coincident; and includes spatial situations where specified functions and/or results (if any) can be carried out and/or achieved. The term deploying is intended to mean designing, building, shipping, installing and/or operating.

The terms first or one, and the phrases at least a first or at least one, are intended to mean the singular or the plural unless it is clear from the intrinsic text of this document that it is meant otherwise. The terms second or another, and the phrases at least a second or at least another, are intended to mean the singular or the plural unless it is clear from the intrinsic text of this document that it is meant otherwise. Unless expressly stated to the contrary in the intrinsic text of this document, the term or is intended to mean an inclusive or and not an exclusive or. Specifically, a condition A or B is satisfied by any one of the following: A is true (or present) and B is false (or not present), A is false (or not present) and B is true (or present), and both A and B are true (or present). The terms a or an are employed for grammatical style and merely for convenience.

The term plurality is intended to mean two or more than two. The term any is intended to mean all applicable members of a set or at least a subset of all applicable members of the set. The term means, when followed by the term “for” is intended to mean hardware, firmware and/or software for achieving a result. The term step, when followed by the term “for” is intended to mean a (sub)method, (sub)process and/or (sub)routine for achieving the recited result.

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. The terms “consisting” (consists, consisted) and/or “composing” (composes, composed) are intended to mean closed language that does not leave the recited method, apparatus or composition to the inclusion of procedures, structure(s) and/or ingredient(s) other than those recited except for ancillaries, adjuncts and/or impurities ordinarily associated therewith. The recital of the term “essentially” along with the term “consisting” (consists, consisted) and/or “composing” (composes, composed), is intended to mean modified close language that leaves the recited method, apparatus and/or composition open only for the inclusion of unspecified procedure(s), structure(s) and/or ingredient(s) which do not materially affect the basic novel characteristics of the recited method, apparatus and/or composition.

Unless otherwise defined, all technical and scientific terms used herein have the same meaning as commonly understood by one of ordinary skill in the art to which this invention belongs. In case of conflict, the present specification, including definitions, will control.

### CONCLUSION

The described embodiments and examples are illustrative only and not intended to be limiting. Although embodiments of the invention can be implemented separately, embodiments of the invention may be integrated into the system(s) with which they are associated. All the embodiments of the invention disclosed herein can be made and used without undue experimentation in light of the disclosure. Although the best mode of the invention contemplated by the inventor(s) is disclosed, embodiments of the invention are not limited thereto. Embodiments of the invention are not limited by theoretical statements (if any) recited herein. The individual steps of embodiments of the invention need not be performed in the disclosed manner, or combined in the disclosed sequences, but may be performed in any and all manner and/or combined in any and all sequences. The individual components of embodiments of the invention need not be formed in the disclosed shapes, or combined in the disclosed configurations, but could be provided in any and all shapes, and/or combined in any and all configurations. The individual components need not be fabricated from the disclosed materials, but could be fabricated from any and all suitable materials. Homologous replacements may be substituted for the substances described herein.

It can be appreciated by those of ordinary skill in the art to which embodiments of the invention pertain that various substitutions, modifications, additions and/or rearrangements of the features of embodiments of the invention may be made without deviating from the spirit and/or scope of the underlying inventive concept. All the disclosed elements and features of each disclosed embodiment can be combined with, or substituted for, the disclosed elements and features of every other disclosed embodiment except where such elements or features are mutually exclusive. The spirit and/or scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” and/or “step for.” Subgeneric embodiments of the invention are delineated by the appended independent claims and their equivalents. Specific embodiments of the invention are differentiated by the appended dependent claims and their equivalents.

### REFERENCES

Marks Mechanical Engineering Handbook, 10th ed., McGraw Hill, (Eugene A. Avallone et al. eds.), 1996.
The Electrical Engineering Handbook, CRC Press, (Richard C. Dorf et al. eds.), 1993.
Handbook of Chemistry and Physics, 81^{st} Edition, CRC Press, 2000.
Perry's Chemical Engineers' Handbook, 6th ed., McGraw Hill, (Robert H. Perry et al. eds.,) 1984.
Kirk-Othmer, Concise Encyclopedia of Chemical Technology, John Wiley & Sons, (Martin Grayson et al. eds.), 1985.

Concise Encyclopedia of Polymer Science and Engineering, John Wiley & Sons, (Jacqueline I. Kroschwitz et al. eds.), 1990.

What is claimed is:

1. A method, comprising making a reticle particle calibration standard including
depositing a solution that includes a plurality of particles onto a first plate;
drying the solution to evaporate a solvent;
bonding the plurality of particles to the first plate;
coupling a second plate to the first plate, the plurality of particles located between the first plate and the second plate,
wherein the plurality of particles include a plurality of traceable standard particles of substantially known shape and size.

2. The method of claim 1, further comprising compiling at least one calibration data map including information regarding the presence and location, with regard to a plane defined by the first plate, of the plurality of traceable standard particles of substantially known shape and size.

3. The method of claim 1, wherein coupling the first plate to the second plate includes bonding the first plate to the second plate with ultraviolet curing adhesive.

4. The method of claim 1, wherein depositing the solution includes nebulizing the solution onto the first plate.

5. The method of claim 1, wherein depositing includes spraying the solution onto the first plate.

6. An apparatus, comprising a reticle particle calibration standard including:
a first plate;
a second plate coupled to the first plate, wherein the second plate is substantially parallel to and coincident with the first plate; and
a plurality of traceable standard particles of substantially known shape and size i) located between the first plate and the second plate and ii) bonded to at least one plate selected from the group consisting of the first plate and the second plate.

7. The apparatus of claim 6, wherein the plurality of traceable standard particles of substantially known shape and size include polystyrene latex spheres.

8. A kit-of-parts comprising the apparatus of claim 6 and at least one calibration data map including information regarding the presence and location, with regard to a plane defined by the first plate, of the plurality of traceable standard particles of substantially known shape and size.

9. A method, comprising using a reticle particle calibration standard to qualify a metrology instrument or monitor performance of the metrology instrument including:
scanning the reticle particle calibration standard using the metrology instrument;
compiling a raw data map of the reticle particle calibration standard;
comparing the raw data map to a calibration data map associated with the reticle particle calibration standard.

10. The method of claim 9, wherein comparing the raw data map to the calibration map includes
determining which particles plotted on the calibration data map were detected; and
determining which particles plotted on the calibration data map were not detected.

11. The method of claim 9, further comprising displaying the raw data map.

12. The method of claim 11, wherein displaying the raw data map includes displaying particles that were detected and are plotted on the calibration data map.

13. The method of claim 12, wherein displaying the raw data map includes displaying adder particles that were detected but are not plotted on the calibration data map.

14. The method of claim 9, further comprising displaying the calibration data map.

15. The method of claim 14, wherein displaying the calibration data map includes displaying particles that were detected and are plotted on the calibration data map.

16. The method of claim 15, wherein displaying the calibration data map includes displaying particles that are plotted on the calibration data map but were not detected.

17. The method of claim 9, further comprising calculating a repeatability score based on i) particles that were detected and are plotted on the calibration data map and ii) particles that are plotted on the calibration data map but were not detected.

18. The method of claim 9, further comprising defining a new standard data map by selectively verifying at least one particle that was detected but is not on the calibration data map and then adding a) the verified particle and b) particles plotted on the calibration data map.
